(19) United States
(12) Patent Application Publication
(10) Pub. No.: US 2024/0395061 A1
(43) Pub. Date: Nov. 28, 2024

(54) VIDEO PROCESSING METHOD, APPARATUS, DEVICE, MEDIUM, AND PROGRAM PRODUCT

(71) Applicants: Lemon Inc., Grand Cayman (KY); Beijing Zitiao Network Technology Co., Ltd., Haidian District (CN); Institute of Automation Chinese Academy of Sciences, Beijing (CN)

(72) Inventors: Xiaojie JIN, Los Angeles, CA (US); Xingjian HE, Beijing (CN); Sihan CHEN, Beijing (CN); Fan MA, Beijing (CN); Zhicheng HUANG, Beijing (CN); Jing LIU, Beijing (CN); Jiashi FENG, Singapore (SG)

(21) Appl. No.: 18/671,708

(22) Filed: May 22, 2024

(30) Foreign Application Priority Data
May 22, 2023 (CN) 202310582633.7

(51) Int. Cl. G06V 20/70; G06V 10/774; G06V 10/80; G06V 20/40

(52) U.S. Cl. CPC G06V 20/70; G06V 10/774; G06V 10/806; G06V 20/46

(57) ABSTRACT

The present disclosure provides a video processing method, apparatus, device, storage medium, and program product. The method includes: acquiring video data; obtaining, based on the video data, a temporal image feature with temporal information; determining, based on the temporal image feature, a target text feature in a set of text features that matches the temporal image feature; and obtaining, based on the target text feature, target text data corresponding to the video data.

### CROSS-REFERENCE TO RELATED APPLICATION(S)

This application claims priority to Chinese Application No. 202310582633.7 filed in May 22, 2023, the disclosures of which are incorporated herein by reference in their entities.

### FIELD

The present disclosure relates to the field of computer technology, and in particular, to a video processing method, apparatus, device, medium, and program product.

### BACKGROUND

Vision Language Pre-training (VLP) technology is often used to improve the performance of various multi-modal video processing tasks. Existing video language pre-training methods usually require high-quality video data and text data for training. However, the amount of high-quality video data and text data is limited and the training cannot be adequately done, resulting in low accuracy and high training costs for the models ultimately used for video processing tasks. Although the Image Language Pre-training (ILP) method can be used to perform pre-training based on a sufficient number of high-quality images, due to differences between image data and video data, as well as different emphasis of their respective processing tasks, the model obtained by using the Image Language Training method cannot improve accuracy and other performance when used in video processing tasks.

### SUMMARY

The present disclosure proposes a video processing method, apparatus, device, storage medium and program product to solve the technical problem of low accuracy of video processing to a certain extent.

A first aspect of the present disclosure provides a video processing method, including: acquiring video data to be processed;
obtaining, based on the video data, a temporal image feature with temporal information; determining, based on the temporal image feature, a target text feature in a set of text features that matches the temporal image feature; and
obtaining, based on the target text feature, target text data corresponding to the video data.

A second aspect of the present disclosure provides a video processing apparatus, including:
an acquisition module configured to acquire video data to be processed;
a model module configured to obtain, based on the video data, a temporal image feature with temporal information; determine, based on the temporal image feature, a target text feature in a set of text features that matches the temporal image feature; and obtain, based on the target text feature, target text data corresponding to the video data.

A third aspect of the present disclosure provides an electronic device, wherein it comprises one or more processors, a memory; and one or more programs, wherein the one or more programs are stored in the memory, and executed by the one or more processors, the program including instructions for performing the method according to the first aspect.

A fourth aspect of the present disclosure provides a non-volatile computer-readable storage medium containing a computer program, which, when executed by one or more processors, causes the processor to execute the method of the first aspect.

A seventh aspect of the present disclosure provides a computer program product including computer program instructions, which, when running on a computer, cause a computer to execute the method of the first aspect.

As it can be seen from the above, a video processing method, apparatus, device, medium, and program product provided by the present disclosure improve the accuracy and effectiveness of multi-modal video processing tasks through obtaining a temporal image feature with temporal information by extracting temporal information of video data, and enhancing the characterization capability of image features using the temporal information.

### BRIEF DESCRIPTION OF THE DRAWINGS

In order to more clearly illustrate the technical solutions in the present disclosure or related technologies, the drawings needed to be used in the description of the embodiments or related technologies will be briefly introduced below. Obviously, the drawings in the following description are only embodiments of the present disclosure, and for those of ordinary skill in the art, other drawings can also be obtained in view of these drawings without exerting creative efforts.

FIG. 1 is a schematic diagram of a video processing architecture according to an embodiment of the present disclosure.

FIG. 2 is a schematic hardware structure diagram of an exemplary electronic device according to an embodiment of the present disclosure.

FIG. 3 is a schematic diagram of a model architecture of a video processing model according to an embodiment of the present disclosure.

FIG. 4 is a schematic structural diagram of a video adapter according to an embodiment of the present disclosure.

FIG. 5 is a schematic principal diagram of a stacked cross-attention structure according to an embodiment of the present disclosure.

FIG. 6 is a schematic principal diagram of a parallel cross-attention structure according to an embodiment of the present disclosure.

FIG. 7 is a schematic flow chart of a video processing method according to an embodiment of the present disclosure.

FIG. 8 is a schematic diagram of a video processing apparatus according to an embodiment of the present disclosure.

### DETAILED DESCRIPTION OF EMBODIMENTS

In order to make the purpose, technical solutions and advantages of the present disclosure even more clear, the present disclosure will be further described in detail below in conjunction with specific embodiments and with reference to the accompanying drawings.

It should be noted that, unless otherwise defined, the technical terms or scientific terms used in the embodiments of present disclosure should have the usual meanings understood by those with ordinary skills in the field to which this disclosure belongs. The “first”, “second” and similar words used in the embodiments of the present disclosure do not indicate any order, quantity or importance, but are only used to distinguish different components. A word, such as “comprise” or “include”, etc., means that an element or item appearing before the word encompasses elements or items listed after the word and their equivalents, without excluding other elements or items. A word, such as “connect” or “connected”, etc., is not limited to physical or mechanical connections, but may include electrical connections, whether direct or indirect. “Up”, “down”, “left”, “right”, etc. are only used to express relative positional relationships. When the absolute position of the described object changes, the relative positional relationship may also change accordingly.

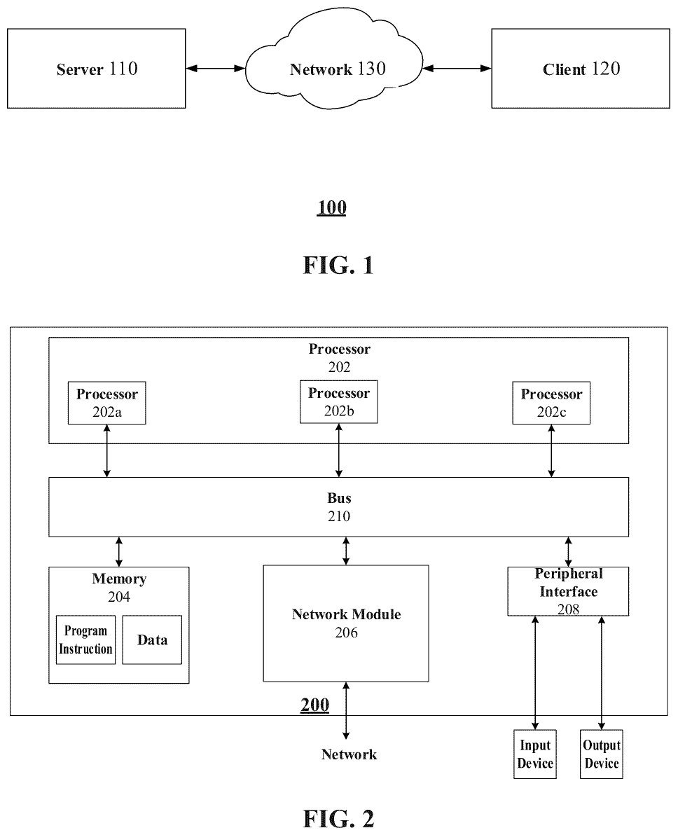

FIG. 1 shows a schematic diagram of a video processing architecture of an embodiment of the present disclosure. Referring to FIG. 1, the video processing architecture 100 may include a server 110, a terminal 120, and a network 130 providing a communication link. The server 110 and the terminal 120 may be connected through a wired or wireless network 130. The server 110 may be an independent physical server, or a server cluster or a distributed system composed of multiple physical servers, or a cloud server that provides basic cloud computing services such as cloud services, cloud databases, cloud computing, cloud functions, cloud storage, network services, cloud communications, middleware services, security services, and CDN.

The terminal 120 may be implemented in hardware or software. For example, when the terminal 120 is implemented in hardware, it may be various kinds of electronic devices that have a display screen and support page display, including but not limited to, a smart phone, a tablet, an e-book reader, a laptop portable computer, a desktop computer, and so on. In the case where the terminal 120 device is implemented in software, it can be installed in an electronic device listed above; which may be implemented as a plurality of software or software modules (for example, software or software modules used to provide distributed services), or may be implemented as a single software or software modules, which are not specifically limited here.

It should be noted that the video processing method provided by the embodiment of the present application may be executed by the terminal 120 or the server 110. It should be understood that the number of terminals, networks and servers in FIG. 1 is only for illustration and is not intended to be limiting. There may be any number of terminals, networks, and servers depending on implementation requirements.

FIG. 2 shows a schematic hardware structure diagram of an exemplary electronic device 200 provided by an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 realize communication connections with each other within the electronic device 200 through the bus 210.

The processor 202 may be a Central Processing Unit (CPU), an image processor, a neural network processor (NPU), a microcontroller (MCU), a programmable logic device, a digital signal processor (DSP), an Application Specific Integrated Circuit (ASIC), or one or more integrated circuits. The processor 202 may be used to perform functions related to the techniques described in this disclosure. In some embodiments, the processor 202 may also include a plurality of processors integrated into a single logical component. For example, as shown in FIG. 2, the processor 202 may include a plurality of processors 202a, 202b, and 202c.

The memory 204 may be configured to store data (e.g., instructions, computer codes, etc.). As shown in FIG. 2, the data stored in the memory 204 may include program instructions (for example, program instructions for implementing the video processing method of the embodiment of the present disclosure) and data to be processed (for example, the memory may store profiles of other modules, etc.). The processor 202 may also access program instructions and data stored in the memory 204 and execute the program instructions to operate on the data to be processed. The memory 204 may include a volatile storage or a non-volatile storage. In some embodiments, the memory 204 may include a random access memory (RAM), a read only memory (ROM), an optical disk, a magnetic disk, a hard drive, a solid state drives (SSD), a flash memory, a memory stick, and the like.

The network module 206 may be configured to provide communication with other external devices to electronic device 200 via a network. The network may be any wired or wireless network capable of transmitting and receiving data. For example, the network may be a wired network, a local wireless network (e.g., Bluetooth, Wi-Fi, Near Field Communication (NFC), etc.), a cellular network, the Internet, or a combination thereof. It is understood that the type of network is not limited to the specific examples above. In some embodiments, the network module 306 may include any combination of any number of network interface controllers (NICs), radio frequency modules, transceivers, modems, routers, gateways, adapters, cellular network chips, and the like.

The peripheral interface 208 may be configured to connect the electronic device 200 with one or more peripheral devices to implement information input and output. For example, the peripheral devices may include input devices such as keyboards, mice, touch pads, touch screens, microphones, and various sensors, as well as output devices such as displays, speakers, vibrators, and indicator lights.

The bus 210 may be configured to transmit information between various components (e.g., the processor 202, the memory 204, the network module 206, and the peripheral interface 208) of the electronic device 200, such as an internal bus (e.g., processor-memory bus), an external bus (USB port, PCI-E bus), etc.

It should be noted that, although the architecture of the electronic device 200 above only shows the processor 202, the memory 204, the network module 206, the peripheral interface 208, and the bus 210, the architecture of the electronic device 200 may also include other components necessary for realizing proper operations in the process of specific implementation. In addition, those skilled in the art can understand that the architecture of the electronic device 200 above may only include components necessary to implement the embodiments of the present disclosure, and does not necessarily include all components shown in the figure.

Existing video language pre-training (VLP) techniques are used to improve the performance of various multi-modal video processing tasks, such as text video retrieval, video subtitles, and video question answering (VQA). Although image-language pre-training (ILP) methods, such as CLIP (Contrastive Language-Image Pre-training), have achieved significant success in learning high-quality visual multi-modal representations. There are problems, however, in transferring such image text models obtained based on such as CLIP into video processing models: in the processing field, due to the difference between image data and video data, the image text models have poor performance when used to process video data; the focuses of processing tasks are different, while the CLIP model mainly handles comparison tasks, the VLP should handle generation tasks, such as video subtitles and video question answering; and the difference in pre-training data, due to curation rules and the availability of open source data, there are significant differences among pre-training data of these models. VLPs usually require high-quality video text data for training, but the amount of such high-quality video text data is relatively limited, resulting in insufficient training data and relatively high training costs. In addition, the CLIP models have defects in processing temporal information, so it may not achieve significant performance improvements when processing video data. And CLIP models are generally targeted at specific tasks (such as text video retrieval), rather than handling all tasks in a unified model. Therefore, how to improve the accuracy and effectiveness of video processing tasks has become an urgent technical issue that needs to be solved.

In view of this, the embodiments of the present disclosure provide a video processing method, apparatus, device, medium, and program product, which improve the accuracy and effectiveness of multi-modal video processing tasks through obtaining a temporal image feature with temporal information by extracting temporal information of video data, and enhancing the characterization capability of image features using the temporal information.

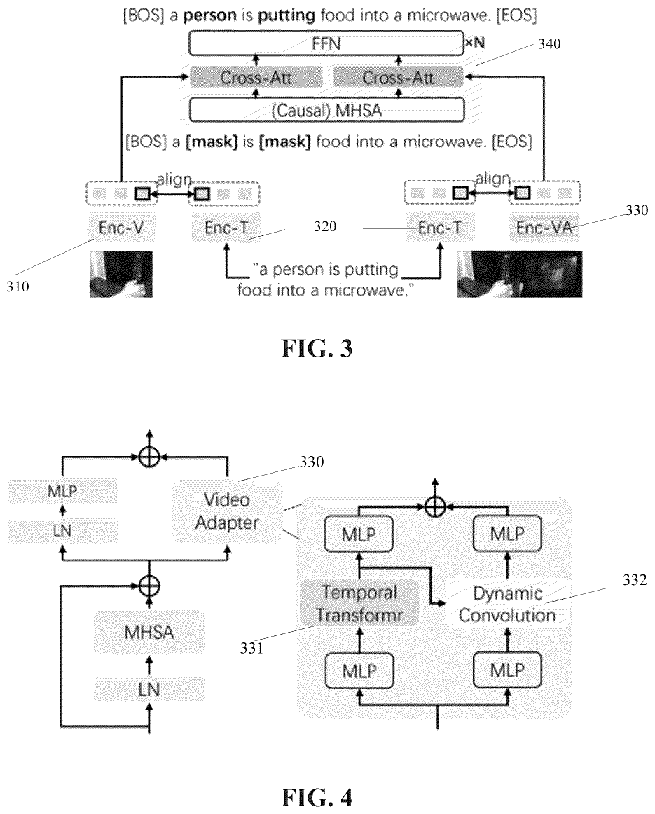

Referring to FIG. 3, which shows a schematic diagram of a video processing model architecture according to an embodiment of the present disclosure. In FIG. 3, the video processing model 300 may include an image encoder 310, a text encoder 320, a video adapter 330, and a multi-modal encoder 340. The input of the image encoder 310 may be a video frame image, and the output may be a corresponding image feature. The input of the text encoder 320 may be text information, and the output may be a text feature corresponding to the input text information. The input of the video adapter 330 may be a sequence of video frames, and the output may be an image feature of specific temporal information. The input of the multi-modal encoder 340 includes the image feature output by the video encoder 310, the text feature output by the text encoder 320, and the image feature of specific temporal information output by the video adapter 330, and a multi-modal fused feature output as fused based on cross-attention mechanism.

In some embodiments, a video adapter may include a temporal network and a dynamic convolutional network. The video adapter can be used to enhance the temporal modeling ability of a model, thereby improving the alignment ability of video and language features. For video frames in video data, it can be divided into multiple image patches, and the video adapter can aggregate temporal information and enhance the representation of each image patch. Referring to FIG. 4, which shows a schematic structural diagram of a video adapter according to an embodiment of the present disclosure. As shown in FIG. 4, the video adapter 330 may include a temporal network 331 and a dynamic convolutional network 332. Video data is input to the video adapter 330, and after passing through multi-layer perceptron MLP (which can be a fully connected layer FC), it is input to the temporal network 331 and the dynamic convolutional network 332 respectively. The temporal network 331 outputs temporal features, including:

$${\tilde{v}}_{[ CLS ]} = {FC}_{2} ( TT ( {FC}_{1} ( {v}_{[ CLS ]} ) ) ) .$$

The temporal network 331 may be a temporal Transformer, v_{[CLS]} may be a category label feature, and V [CLS] may be an updated category label feature, which encodes visual temporal information context and can be used as a temporal feature.

For each image patch, a temporal feature can be used to enhance characterization of an image patch feature of the image patch, and spatio-temporal information of the image patch is encoded to obtain a convolutional feature, including:

$${\tilde{v}}_{patch} = {FC}_{4} ( DyConv ( {\tilde{v}}_{[ CLS ]} , {FC}_{3} ( {v}_{patch} ) ) ) ,$$

v_{patch} is an image patch feature, and DyConv is a convolutional operation, which applies a kernel from category label features of the temporal to a feature of a spatial image patch to obtain the encoded video temporal feature of the image patch to improve its characterization capability. The temporal feature and convolutional feature can be connected to obtain a second image feature \tilde{v}=[\tilde{v}_{[CLS]}, \tilde{v}_{patch}]∈ [symbol] ^{N×T×d}.

In some embodiments, for the video processing model, an initial model is pre-trained based on a training sample, the pre-training specifically including:
acquiring the training sample, the training sample including an image sample, a video sample, and a text sample;
performing feature extraction based on the image sample to obtain an image feature sample, performing feature extraction based on the text sample to obtain a text feature sample, and performing feature extraction based on the video sample to obtain a video feature sample with temporal information;
performing fusion based on the image feature sample, the text feature sample, and the video feature sample to obtain a multi-modal fused feature; and
performing pre-training on the initial model based on the training sample and the multi-modal fused feature.

The initial model can be pre-trained based on the training sample to obtain a pre-trained model. In some embodiments, the training sample may include at least one combination including an image sample, a video sample, and a text sample. The image sample may be a video frame of a video sample. For example, a training sample <I, V, T> includes image sample I, video sample V, and corresponding text sample T. The text sample T can be used to describe the content of the video sample V, and the image sample I can be a video frame in video sample V. Videos that are pre-annotated or matched with corresponding text can be used as video-text pairs.

In some embodiments, performing fusion based on the image feature sample, the text feature sample, and the video feature sample to obtain a multi-modal fused feature includes:
performing self-attention calculation based on the text feature sample to obtain a text self-attention feature;
performing cross-attention calculation based on the text self-attention feature and the image feature sample to obtain a text-image attention feature; and
performing cross-attention calculation based on the text-image attention feature and the video feature sample to obtain the multi-modal fused feature.

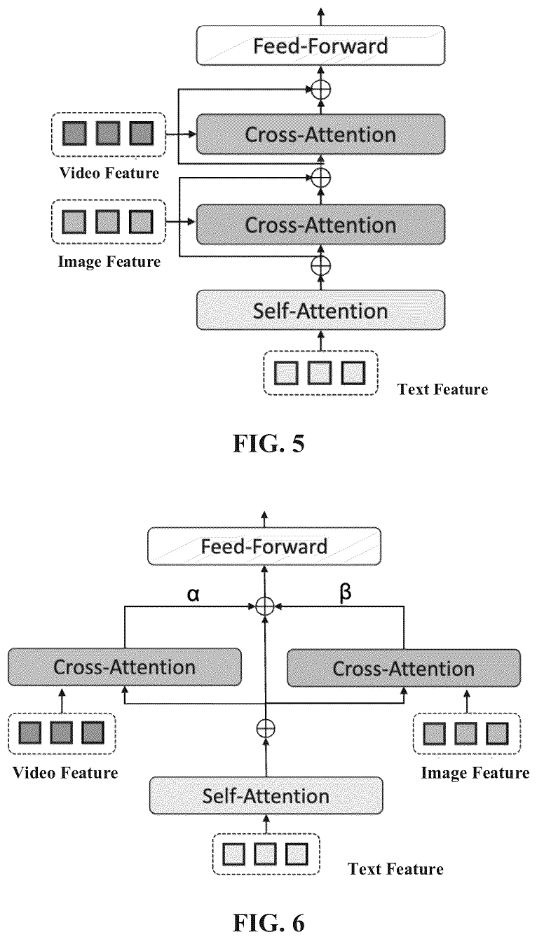

Cross-attention layers can be stacked to process the output features of the image encoder and the video adapter separately. For example, one or more stacked structures can be adopted, each stacked structure including a Self-Attention layer, two Cross-Attention layers, and a Feed-Forward layer. Referring to FIG. 5, which shows a schematic principal diagram of a stacked cross-attention structure according to an embodiment of the present disclosure. As shown in FIG. 5, the output of the stacked cross-attention structure may include:

$${x}_{l}^{ca} = {CA}^{v} ( {CA}^{i} ( {x}_{l}^{sa} ; I ) ; v ) ,$$

xₗ^{ca} is an output feature of the cross-attention layer in the l-th image patch, xₗ^{sa} is an output feature of the self-attention layer in the l-th image patch, CA^{v} is an output feature of the video adapter, CAⁱ is an output feature of the image encoder, I is an image feature, and v is a video feature.

In some embodiments, performing fusion based on the image feature sample, the text feature sample, and the video feature sample to obtain a multi-modal fused feature includes:
performing self-attention calculation based on the text feature sample to obtain a text self-attention feature;
performing cross-attention calculation based on the text self-attention feature and the image feature sample to obtain a text-image attention feature; and performing cross-attention calculation based on the text self-attention feature and the video feature sample to obtain a text-video attention feature; and
weighting based on the text-image attention feature and the text-video attention feature to obtain the multi-modal fused feature.

Cross-attention layers set in parallel can be adopted to process the output features of the image encoder and the video adapter separately. Referring to FIG. 6, which shows a schematic principal diagram of a parallel cross-attention structure according to an embodiment of the present disclosure. As shown in FIG. 6, the output of the parallel cross-attention structure may include:

$${x}_{l}^{ca} = α \cdot {CA}^{v} ( {x}_{l}^{sa} ; v ) + β \cdot {CA}^{i} ( {x}_{l}^{sa} ; I ) ,$$

α and β are weight parameters and can be adjusted adaptively.

In some embodiments, performing pre-training on the initial model based on the training sample and the multi-modal fused feature includes:
performing a first pre-training based on the training sample and the multi-modal fused feature, adjusting adapter parameters of the video adapter, and keeping non-adapter parameters of the initial model unchanged so that the loss function best satisfies training requirements; and
performing a second pre-training based on the training sample and the multi-modal fused feature, and adjusting all parameters of the initial model so that the loss function satisfies the training requirements.

Specifically, when performing pre-training on the initial model, the training process can be divided into two stages, adaptive transferring and ensemble tuning. In the adaptive transferring stage, the first pre-training can be performed based on a training sample, adjusting parameters of the video adapter and fixing other parameters of the initial model. In the ensemble tuning stage, the second pre-training can be performed based on the same training sample, adjusting all parameters of the video adapter to further improve the performance of the pre-trained model obtained from pre-training.

In FIG. 3, the image sample 311 can be input to the image encoder 310 for feature extraction to obtain the image feature sample Fi; the text sample 321 can be input to the text encoder 320 for feature extraction to obtain the text feature sample Ft; and the video sample 331 can be input to the video adapter 330 for feature extraction to obtain the video feature sample Fv with temporal information. The image feature sample Fi, the text feature sample Ft, and the video feature sample Fv are input to the multi-modal encoder 340 for feature fusion to obtain a multi-modal fused feature.

In some embodiments, performing pre-training on the initial model based on the training sample and the multi-modal fused feature includes:
using the image sample and corresponding text sample as positive sample pairs, and using the image sample and non-corresponding text sample in the training samples as negative sample pairs;
calculating a first similarity of the positive sample pairs and a second similarity of the negative sample pairs; and
adjusting a first model parameter of the initial model so that the first similarity is minimum and the second similarity is maximum.

A contrast loss function of image-text contrastive learning (ITC) can be used to align the two visual representations of image features and video features, and then feed the visual representation into the multi-modal encoder. Specifically, an image sample and its corresponding text sample can be regarded as one positive sample pair, while all other samples in the same batch are regarded as negative sample pairs. Then, the loss is calculated by calculating the cosine similarity distance between them. Comparing the distance between positive and negative pairs can make the distance between positive sample pairs closer and the distance between negative sample pairs farther. In this way, a better semantic structure can be established in the representation space, thereby improving visual-text matching and retrieval.

In some embodiments, performing pre-training on the initial model based on the training sample and the multi-modal fused feature includes:
generating a text masked sample based on the text sample;
performing self-attention calculation based on the text masked sample to obtain a first text masked self-attention feature;
performing cross-attention calculation based on the image feature sample and the first text masked self-attention feature to obtain a first image-text masked cross-attention feature;
and performing cross-attention calculation based on the video feature sample and the first text masked self-attention feature to obtain a first video-text masked cross-attention feature;
obtaining a first loss function based on the first image-text masked cross-attention feature, the first video-text masked cross-attention feature, and the multi-modal fused feature; and
adjusting model parameters of the initial model based on the first loss function to minimize the first loss function.

Specifically, Masked Language Modeling (MLM) can be adopted to encourage the model to generate captions given a visual representation. Since the multi-modal fusion feature is based on the Cross-attention Transformer, it enables the model to query information in the visual representation to generate text tags. Therefore, this training task can effectively promote the fusion of visual and textual information.

In some embodiments, a text masked sample can be obtained based on a text sample and a preset text mask policy. Further, obtaining a text masked sample based on a text sample and a preset text mask policy includes: randomly selecting a preset proportion of words in the text sample for masking to generate the text masked sample. For example, in FIG. 3, the text sample is “a person is putting food into a microwave.”, which contains 8 words, wherein the preset proportion (for example, 30%) is about 2, then two preset type words in the text sample can be randomly masked to obtain the text “a [mask] is [mask] food into a microwave.” as a text masked sample. It should be understood that the number of the preset proportion of words may not be an integer, and can be rounded to an integer (for example, rounding) for masking as needed, which is not limited here.

In some embodiments, performing pre-training on the initial model based on the training sample and the multi-modal fused feature includes:
generating a text masked sample based on the text sample;
performing causal self-attention calculation based on the text masked sample to obtain a second text masked self-attention feature;
performing cross-attention calculation based on the image feature sample and the second text masked self-attention feature to obtain a second image-text masked cross-attention feature; and performing cross-attention calculation based on the video feature sample and the second text masked self-attention feature to obtain a second video-text masked cross-attention feature;
obtaining a second loss function based on the second image-text masked cross-attention feature, the second video-text masked cross-attention feature, and the multi-modal fused feature; and
adjusting model parameters of the initial model based on the second loss function so that the second loss function is minimized.

Specifically, in order to enhance the integration of visual and textual information, Uni-ML can be adopted as an additional training task, both of which use the same multi-modal encoder except for the MLM task. The difference between the two tasks is the self-attention mechanism of Transformer. Uni-ML uses causal self-attention masking to regulate the interaction between text inputs. This encourages the generated text tags to rely heavily on visual and text input, thus promoting a more effective fusion of the two modalities.

After the above pre-training stage, a pre-trained model is obtained. On this basis, the pre-trained model can be trained specifically for different downstream tasks to obtain multi-modal data models for different downstream tasks.

In some embodiments, it may also include: training the pre-trained model based on a task training sample to obtain the video processing model.

Further, in some embodiments, training the pre-trained model based on the task training sample to obtain the video processing model may further include:
acquiring the task training sample, the second training sample including at least one video-text training pair, each video-text training pair including a video training sample and a corresponding text training sample; and
training the pre-trained model based on the task training sample until target training requirements are met, to obtain the video processing model.

For different video processing tasks, contents contained in the task training samples may be different. For example, for a video information generation task, the video processing model can generate text information (such as summary, title, introduction, etc.) associated with the video data based on the video data. Then, the task training samples corresponding to the video information generation task may include at least one video-text information pair, and each video-text information pair includes a video training sample and corresponding text information such as summary, title, introduction, etc. As it can be seen, due to the pre-trained model obtained according to the video processing method of the embodiment of the present disclosure, high efficiency and high performance can be guaranteed.

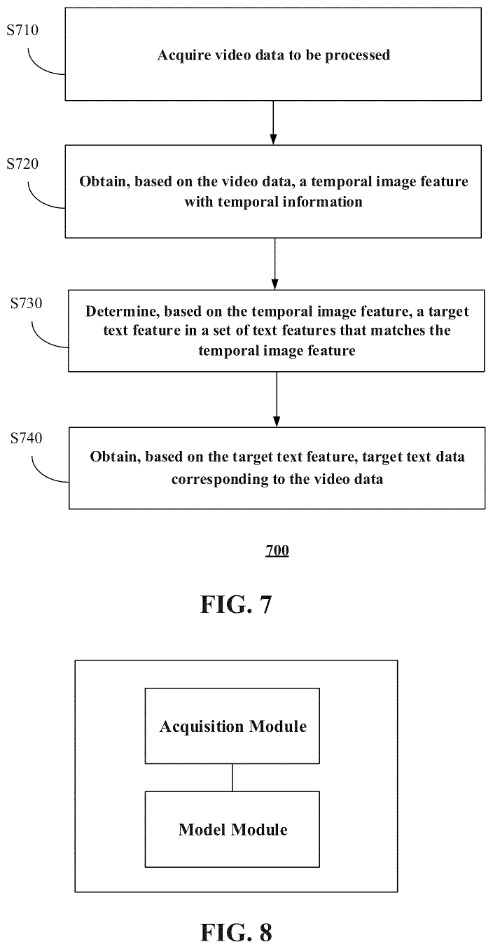

Referring to FIG. 7, which shows a schematic flow chart of a video processing method according to an embodiment of the present disclosure. As shown in FIG. 7, the video processing method 700 may be implemented based on the video processing model shown in FIG. 3, and further includes the following steps.

Step S710: Acquiring video data to be processed.

Step S720: Obtaining, based on the video data, a temporal image feature with temporal information.

In some embodiments, obtaining, based on the video data, a temporal image feature with temporal information includes:
performing feature extraction based on video frames of the video data to obtain a first image feature and a second image feature with temporal information; and
obtaining the temporal image feature by fusing the first image feature and the second image feature.

Specifically, a first image feature can be obtained based on the image encoder 310 performing feature extraction on video frames, and a second image feature with temporal information can be obtained based on the video adapter 330 performing feature extraction on video data. The first image feature and the second image feature are performed feature fusion via the multi-modal encoder 340 to obtain a temporal image feature.

In some embodiments, performing feature extraction based on video frames of the video data to obtain a second image feature with temporal information includes:
extracting, based on the video data, an image patch feature of an image patch in a video frame and a temporal feature of the video frame; and
obtaining the second image feature based on a fusion of the temporal feature and the image patch feature.

Specifically, temporal feature extraction may be performed on video data based on the temporal network 331 in the video adapter 330, and an image patch feature of a video frame and the temporal feature can be fused based on the dynamic convolutional network 332 to obtain a second image feature with temporal information.

Step S730: Determining, based on the temporal image feature, a target text feature in a set of text features that matches the temporal image feature.

Step S740: Obtaining, based on the target text feature, target text data corresponding to the video data.

Specifically, for video data to be processed, the user wishes to generate corresponding summary information for the video data. The video processing model can perform feature extraction on the video data to obtain a temporal image feature with temporal information, and the temporal image feature can be a feature vector. The video processing model performs searching and matching in a set of text features based on the temporal image feature. The set of text features may be a set of text features obtained after performing feature extraction on a preset text. After searching and matching, one or more target text features that match the temporal image feature can be obtained. Based on a target preset text corresponding to the one or more target text features, target text about the video data can be formed as summary information. According to the video processing method of the embodiment of the present disclosure, the video processing model is used to generate relevant text information based on a video, which can improve the accuracy of the text information.

It should be noted that the methods in the embodiments of the present disclosure can be executed by a single device, such as a computer or a server, etc. The method of the embodiment may also be applied in a distributed scenario, and is completed by multiple devices cooperating with each other. In this distributed scenario, one device among the multiple devices may only perform one or more steps in the method of the embodiment of the present disclosure, and these multiple devices will interact with each other to complete said method.

It should be noted that some embodiments of the present disclosure have been described above. Other embodiments are within the scope of the appended claims. In some cases, actions or steps recited in the claims can be performed in a different order than in the above embodiments and still achieve desired results. Additionally, the processes depicted in the drawings do not necessarily require the specific order shown, or sequential order, to achieve desirable results. In certain implementations, multitasking and parallel processing are also possible or may be advantageous.

Based on the same technical concept, corresponding to any of the above embodiment methods, the present disclosure further provides a video processing apparatus. With reference to FIG. 8, the video processing apparatus includes:
an acquisition module configured to acquire video data to be processed; and
a model module configured to obtain, based on the video data, a temporal image feature with temporal information; determine, based on the temporal image feature, a target text feature in a set of text features that matches the temporal image feature; and obtain, based on the target text feature, target text data corresponding to the video data.

For ease of description, when describing the above apparatus, functions are divided into various modules and described separately. Of course, when implementing the present disclosure, functions of various modules may be implemented in the same one or more software and/or hardware.

The apparatus of the above embodiment is used to implement respective video processing methods in any of the foregoing embodiments, and have the beneficial effects of the respective method embodiments, which will not be repeated here again.

Based on the same technical concept, corresponding to any of the above embodiment methods, the present disclosure further provides a non-transitory computer-readable storage medium having computer instructions stored thereon, which are configured to cause the computer to execute the video processing method of any of the above embodiments.

The computer-readable medium in the embodiment includes permanent and non-permanent, removable and non-removable media, and information storage can be implemented by any method or technology. Information may be computer-readable instructions, data structures, program modules, or other data. Examples of computer storage media include, but not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a magnetic tape cassette, a tape magnetic disk storage or other magnetic storage devices or any other non-transmission medium that can be used to store information that can be accessed by a computing device.

The computer instructions stored in the storage medium of the above embodiments are configured to cause the computer to execute the video processing method of any of the above embodiments, and have the beneficial effects of respective method embodiments, which will not be repeated here again.

Those of ordinary skill in the art should understand that the discussion of any above embodiments is only illustrative, and is not intended to imply that the scope of the present disclosure (including the claims) is limited to these examples; under the spirit of the present disclosure, the technical features in the above embodiments or different embodiments may also be combined, and the steps may be implemented in any order, and there are many other variations of different aspects of the above embodiments of the present disclosure, which are not provided in detail for the sake of brevity.

Additionally, in order to simplify illustration and discussion, and so as not to obscure embodiments of the present disclosure, well-known power supplies/ground connections with integrated circuit (IC) chips and other components may or may not be shown in the provided drawings. Furthermore, apparatus may be shown in the form of block diagram in order to avoid obscuring the embodiments of the present disclosure, and this also takes into account the fact that details regarding the implementation of these block diagram apparatus are highly dependent on the platform for implementing of the embodiments of the present disclosure (i.e., these details should be well within the understanding of those skilled in the art). Where specific details (e.g., circuits) are set forth to describe exemplary embodiments of the present disclosure, it will be apparent to those skilled in the art that the embodiments of the present disclosure may be practiced without these specific details or with changes in these specific details. Accordingly, these descriptions should be considered illustrative rather than restrictive.

Although the present disclosure has been described in conjunction with specific embodiments thereof, many alternatives, modifications and variations to these embodiments will be apparent to those of ordinary skill in the art from the foregoing description. For example, other memory architectures (e.g., dynamic RAM (DRAM)) may use the discussed embodiments.

The embodiments of the present disclosure are intended to embrace all such alternatives, modifications and variations that fall within the broad scope of the appended claims. Therefore, any omissions, modifications, equivalent substitutions, improvements, etc. made within the spirit and principles of the embodiments of the present disclosure shall be included in the protection scope of the present disclosure.

I/We claim:

1. A video processing method, including:
acquiring video data to be processed;
obtaining, based on the video data, a temporal image feature with temporal information;
determining, based on the temporal image feature, a target text feature in a set of text features that matches the temporal image feature; and
obtaining, based on the target text feature, target text data corresponding to the video data.

2. The method according to claim 1, wherein obtaining, based on the video data, a temporal image feature with temporal information includes:
performing feature extraction based on video frames of the video data to obtain a first image feature and a second image feature with temporal information; and
obtaining the temporal image feature by fusing the first image feature and the second image feature.

3. The method according to claim 2, wherein performing feature extraction based on video frames of the video data to obtain a second image feature with temporal information includes:
extracting, based on the video data, an image patch feature of an image patch in a video frame and a temporal feature of the video frame; and
obtaining the second image feature based on a fusion of the temporal feature and the image patch feature.

4. The method according to claim 3, wherein obtaining the second image feature based on the fusion of the temporal feature and the image patch feature includes:
obtaining a convolutional feature based on a convolution operation of the temporal feature and the image patch feature; and
obtaining the second image feature by connecting the temporal feature and the convolutional feature.

5. The method according to claim 1, wherein obtaining, based on the video data, a temporal image feature with temporal information includes:
performing feature extraction on the video data based on a video processing model to obtain the temporal image feature; wherein, for the video processing model, an initial model is pre-trained based on a training sample, the pre-training specifically including:
acquiring the training sample, the training sample including an image sample, a video sample, and a text sample;
performing feature extraction based on the image sample to obtain an image feature sample, performing feature extraction based on the text sample to obtain a text feature sample, and performing feature extraction based on the video sample to obtain a video feature sample with temporal information;
performing fusion based on the image feature sample, the text feature sample, and the video feature sample to obtain a multi-modal fused feature; and
performing pre-training on the initial model based on the training sample and the multi-modal fused feature.

6. The method according to claim 5, wherein performing fusion based on the image feature sample, the text feature sample, and the video feature sample to obtain a multi-modal fused feature includes:
performing self-attention calculation based on the text feature sample to obtain a text self-attention feature;
performing cross-attention calculation based on the text self-attention feature and the image feature sample to obtain a text-image attention feature; and
performing cross-attention calculation based on the text-image attention feature and the video feature sample to obtain the multi-modal fused feature.

7. The method according to claim 5, wherein performing fusion based on the image feature sample, the text feature sample, and the video feature sample to obtain a multi-modal fused feature includes:
performing self-attention calculation based on the text feature sample to obtain a text self-attention feature;
performing cross-attention calculation based on the text self-attention feature and the image feature sample to obtain a text-image attention feature; and performing cross-attention calculation based on the text self-attention feature and the video feature sample to obtain a text-video attention feature; and
weighting based on the text-image attention feature and the text-video attention feature to obtain the multi-modal fused feature.

8. The method according to claim 5, wherein the initial model includes a video adapter for extracting an image feature with temporal information, and performing pre-training on the initial model based on the training sample and the multi-modal fused feature includes:
performing the first pre-training based on the training sample and the multi-modal fused feature, adjusting adapter parameters of the video adapter and keeping non-adapter parameters of the initial model unchanged so that a loss function best satisfies training requirements; and
performing the second pre-training based on the training sample and the multi-modal fused feature, and adjusting all parameters of the initial model so that the loss function satisfies the training requirements.

9. An electronic device, comprising:
a memory storing a computer program thereon; and
a processor for execution of the computer program in the memory to perform operations including:
acquiring video data to be processed;
obtaining, based on the video data, a temporal image feature with temporal information;
determining, based on the temporal image feature, a target text feature in a set of text features that matches the temporal image feature; and
obtaining, based on the target text feature, target text data corresponding to the video data.

10. The electronic device according to claim 9, wherein the operations further include:
performing feature extraction based on video frames of the video data to obtain a first image feature and a second image feature with temporal information; and
obtaining the temporal image feature by fusing the first image feature and the second image feature.

11. The electronic device according to claim 10, wherein the operations further include:
extracting, based on the video data, an image patch feature of an image patch in a video frame and a temporal feature of the video frame; and
obtaining the second image feature based on a fusion of the temporal feature and the image patch feature.

12. The electronic device according to claim 11, wherein the operations further include:
obtaining a convolutional feature based on a convolution operation of the temporal feature and the image patch feature; and
obtaining the second image feature by connecting the temporal feature and the convolutional feature.

13. The electronic device according to claim 9, wherein the operations further include:
performing feature extraction on the video data based on a video processing model to obtain the temporal image feature; wherein, for the video processing model, an initial model is pre-trained based on a training sample, the pre-training specifically including:
acquiring the training sample, the training sample including an image sample, a video sample, and a text sample;
performing feature extraction based on the image sample to obtain an image feature sample, performing feature extraction based on the text sample to obtain a text feature sample, and performing feature extraction based on the video sample to obtain a video feature sample with temporal information;
performing fusion based on the image feature sample, the text feature sample, and the video feature sample to obtain a multi-modal fused feature; and
performing pre-training on the initial model based on the training sample and the multi-modal fused feature.

14. The electronic device according to claim 13, wherein the operations further include:
performing self-attention calculation based on the text feature sample to obtain a text self-attention feature;
performing cross-attention calculation based on the text self-attention feature and the image feature sample to obtain a text-image attention feature; and
performing cross-attention calculation based on the text-image attention feature and the video feature sample to obtain the multi-modal fused feature.

15. The electronic device according to claim 13, wherein the operations further include:
performing self-attention calculation based on the text feature sample to obtain a text self-attention feature;
performing cross-attention calculation based on the text self-attention feature and the image feature sample to obtain a text-image attention feature; and performing cross-attention calculation based on the text self-attention feature and the video feature sample to obtain a text-video attention feature; and
weighting based on the text-image attention feature and the text-video attention feature to obtain the multi-modal fused feature.

16. The electronic device according to claim 13, wherein the operations further include:
performing the first pre-training based on the training sample and the multi-modal fused feature, adjusting adapter parameters of the video adapter and keeping non-adapter parameters of the initial model unchanged so that a loss function best satisfies training requirements; and
performing the second pre-training based on the training sample and the multi-modal fused feature, and adjusting all parameters of the initial model so that the loss function satisfies the training requirements.

17. A non-transitory computer-readable storage medium having computer instructions stored thereon, which, when executed by a computer, cause the computer to perform operations including:
acquiring video data to be processed;
obtaining, based on the video data, a temporal image feature with temporal information;
determining, based on the temporal image feature, a target text feature in a set of text features that matches the temporal image feature; and
obtaining, based on the target text feature, target text data corresponding to the video data.

18. The non-transitory computer-readable storage medium according to claim 17, wherein the operations further include:
performing feature extraction based on video frames of the video data to obtain a first image feature and a second image feature with temporal information; and
obtaining the temporal image feature by fusing the first image feature and the second image feature.

19. The non-transitory computer-readable storage medium according to claim 18, wherein the operations further include:
extracting, based on the video data, an image patch feature of an image patch in a video frame and a temporal feature of the video frame; and
obtaining the second image feature based on a fusion of the temporal feature and the image patch feature.

20. The non-transitory computer-readable storage medium according to claim 19, wherein the operations further include:
obtaining a convolutional feature based on a convolution operation of the temporal feature and the image patch feature; and
obtaining the second image feature by connecting the temporal feature and the convolutional feature.
